(19) United States
(12) Patent Application Publication
(10) Pub. No.: US 2017/0274586 A1
(43) Pub. Date: Sep. 28, 2017

(54) THREE-DIMENSIONAL OBJECT FORMING DEVICE AND THREE-DIMENSIONAL OBJECT FORMING METHOD

(71) Applicant: MIMAKI ENGINEERING CO., LTD., NAGANO (JP)

(72) Inventors: Kunio Hakkaku, NAGANO (JP); Nobuo Kanai, NAGANO (JP)

(73) Assignee: MIMAKI ENGINEERING CO., LTD., NAGANO (JP)

(21) Appl. No.: 15/505,246

(22) PCT Filed: Aug. 25, 2015
(86) PCT No.: PCT/JP2015/073796

§ 371 Date: Feb. 20, 2017

(30) Foreign Application Priority Data
Aug. 26, 2014 (JP) 2014-172084

(51) Int. Cl. B29C 67/00; B33Y 30/00; B33Y 10/00

(52) U.S. Cl. CPC B29C 67/0059; B33Y 10/00; B33Y 30/00; B29K 2105/0058

(57) ABSTRACT

An overhanging portion of a three-dimensional object is formed in the absence of a support material. An inkjet head unit of a three-dimensional object forming device according to an aspect of the invention discharges an ink at a time of forming a next layer on a layer previously formed, so as to have part of the ink forming an end of the next layer that is close to an end of the layer previously formed, overlap with the ink forming the end of the layer previously formed to provide a void immediately below the remaining part of the ink of the next layer.

### TECHNICAL FIELD

This invention relates to a three-dimensional object forming device and a three-dimensional object forming method, more particularly to a device and a method for forming a three-dimensional object through ink deposition.

### BACKGROUND ART

Some of the known methods and apparatuses leverage the lamination technique and inkjet printing to form three-dimensional objects. Such methods and apparatuses form a laminate of plural layers by depositing inks to obtain three-dimensional objects in desired three-dimensional shapes, and are expected to be useful in a broad range of applications in different fields.

This three-dimensional shaping technique may be used to obtain objects structured such that the upper one of two laminated layers has an outer peripheral end greater than that of the lower layer, i.e., the upper layer partly further protrude outward than the lower layer (overhanging structure). To this end, a support material may be conventionally formed in contiguity with the outer peripheral end of the lower layer, and an overhanging portion of the upper layer is laminated on the support material. The support material, which is not a structural component of a three-dimensional object to be formed, will be removed later at an appropriate timing. Patent Literature 1, for example, describes technical features using such a support material.

### CITATION LIST

### Patent Literature

Patent Literature 1: Japanese Unexamined Patent Publication No. H06-179243 (published on Jun. 28, 1994)

### SUMMARY

### Technical Problems

The three-dimensional shaping technique that uses a support material, however, requires an additional step of removing the support material. This may be a bottleneck in meeting the need to speedily provide a three-dimensional object. Besides, such a technique involving later disposal of the support material is certainly not eco-friendly.

To address these issues, this invention provides a three-dimensional object forming device and a three-dimensional object forming method that may enable the formation of an overhanging portion in the absence of a support material.

### Solutions to Problems

A three-dimensional object forming device according to this invention forms a three-dimensional object by layering a plurality of layers made of ink. This three-dimensional object forming device is configured to discharge an ink at a time of forming a next layer on a layer previously formed, so as to have part of the ink forming an end of the next layer that is close to an end of the layer previously formed, overlap with the ink forming the end of the layer previously formed to provide a void immediately below the remaining part of the ink of the next layer.

Such a device may dispense with the use of a support material to form the overhanging portion.

In an inner region relative to the end of the ink layer previously formed, part of the ink forming the next ink layer, which is close to the end, overlaps with the ink of the previous layer to provide a void immediately below the remaining part of the ink of the next layer. The remaining part of the ink with a void immediately therebelow constitutes the overhanging portion protruding from the end of the ink-deposited layer previously formed.

The three-dimensional object forming device using the forming method may successfully form the overhanging portion without using any support material. Such a device may dispense with the labor of forming a support material, thereby reducing associated costs conventionally required to form a support material. According to this invention, removal of a support material may become unnecessary. This may expedite the forming of a three-dimensional object as compared with the conventional means requiring the use of a support material. This invention having no need for the waste disposal of a support material may allow a three-dimensional object to be formed in an eco-friendly manner.

In an aspect of the three-dimensional object forming device according to this invention, the ink may be a transparent ink.

Using the transparent ink to form the overhanging portion may form the overhanging portion without affecting the color tone of a three-dimensional object.

In an aspect of the three-dimensional object forming device according to this invention, the ink may be an ultraviolet curing-type ink.

The ultraviolet curing-type ink may be quickly curable. This may facilitate the process of laminating ink layers, allowing a three-dimensional object to be manufactured in a shorter period of time.

In an aspect of the three-dimensional object forming device according to this invention, the device may include a pressing mechanism that contacts and presses an uppermost one of the ink layers from above.

The ink layer, being pressed by the pressing mechanism, may become flat and uniform in thickness. Further, the pressing mechanism may stretch the ink layer in the planar direction thereof, facilitating the formation of the overhanging portion.

In an aspect of the three-dimensional object forming device according to this invention, the pressing mechanism may be a roller that rotates while moving in contact with an upper surface of the layer to be pressed and that rotates at a position of contact in a direction opposite to a moving direction.

Such a roller may move, pressing the upper surface of the uppermost ink layer downward without sliding on the layer (rubbing the layer). This may allow the roller to continue to move in the moving direction while constantly pressing the uppermost layer from above.

In an aspect of the three-dimensional object forming device according to this invention, the roller may have a surface made of a material with no affinity to the ink.

This may prevent the ink from being adhered to the roller surface.

A three-dimensional object forming method according to this invention forms is a three-dimensional object by layering a plurality of layers made of ink. This three-dimensional object forming method includes a discharging step of discharging an ink at a time of forming a next layer on a layer previously formed, so as to have part of the ink forming an end of the next layer that is close to an end of the layer previously formed, overlap with the ink forming the end of the layer previously formed to provide a void immediately below the remaining part of the ink of the next layer.

Such a method may dispense with the use of a support material to form the overhanging portion.

In an inner region relative to the end of the ink layer previously formed, part of the ink forming the next ink layer, which is close to the end, overlaps with the ink of the previous layer to provide a void immediately below the remaining part of the ink of the next layer. The remaining part of the ink with a void immediately therebelow constitutes the overhanging portion formed on the end of the ink-deposited layer previously formed and protruding from this end.

The forming method thus characterized may successfully form the overhanging portion without using any support material. Such a method can dispense with the labor of forming a support material, thereby reducing associated costs conventionally required to form a support material. According to this invention, removal of a support material may become unnecessary. This may expedite the forming of a three-dimensional object as compared with the conventional means requiring the use of a support material. This invention has no need for the waste disposal of a support material, and may allow a three-dimensional object to be formed in an eco-friendly manner.

### Effect of the Invention

This invention may allow the overhanging portion of the three-dimensional object to be formed in the absence of a support material.

### BRIEF DESCRIPTION OF THE DRAWINGS

FIG. 1A is an external view of a three-dimensional object formed by a three-dimensional object farming device according to an embodiment of this invention.

FIG. 1B is a cross-sectional view of the three-dimensional object along a cutting-plane line A-A′ illustrated in FIG. 1A.

FIG. 2 is a schematic drawing of an exemplified nozzle-hole side of an inkjet head unit that is equipped in the three-dimensional object forming device according to the embodiment.

FIGS. 3A and 3B are schematic drawings, illustrating the concept of forming of a three-dimensional object carried out by the three-dimensional object forming device and the three-dimensional object forming method according to the embodiment.

FIGS. 4A to 4E are drawings, schematically illustrating states of a three-dimensional object being formed by the three-dimensional object forming device according to the embodiment.

FIG. 5 is an external view of another three-dimensional object formed by the three-dimensional object forming device according to the embodiment.

FIG. 6 is a schematic drawing of another exemplified nozzle-hole side of an inkjet head unit that may be equipped in the three-dimensional object forming device according to the embodiment.

FIG. 7 is a schematic drawing of further another exemplified nozzle-hole side of an inkjet head unit that is equipped in the three-dimensional object forming device according to the embodiment.

FIG. 8 is a schematic drawing of further another exemplified nozzle-hole side of an inkjet head unit that is equipped in the three-dimensional object forming device according to the embodiment.

FIG. 9 is a schematic drawing of further another exemplified nozzle-hole side of an inkjet head unit that is equipped in the three-dimensional object forming device according to the embodiment.

FIG. 10 is a schematic drawing of an inkjet head unit equipped in a three-dimensional object forming device according to another embodiment of this invention.

FIG. 11 schematically illustrates a process of manufacturing a three-dimensional object using the three-dimensional object forming device according to another embodiment.

FIG. 12 schematically illustrates the process of manufacturing a three-dimensional object using the three-dimensional object forming device according to another embodiment.

FIGS. 13A and 13B schematically illustrate the process of manufacturing a three-dimensional object using the three-dimensional object forming device according to another embodiment.

### DESCRIPTION OF EMBODIMENTS

A three-dimensional object forming device and a three-dimensional object forming method according to an embodiment of this invention are hereinafter described. The description starts with a three-dimensional object formed by the three-dimensional object forming device and method according to the embodiment.

(1) Summary of Three-Dimensional Object

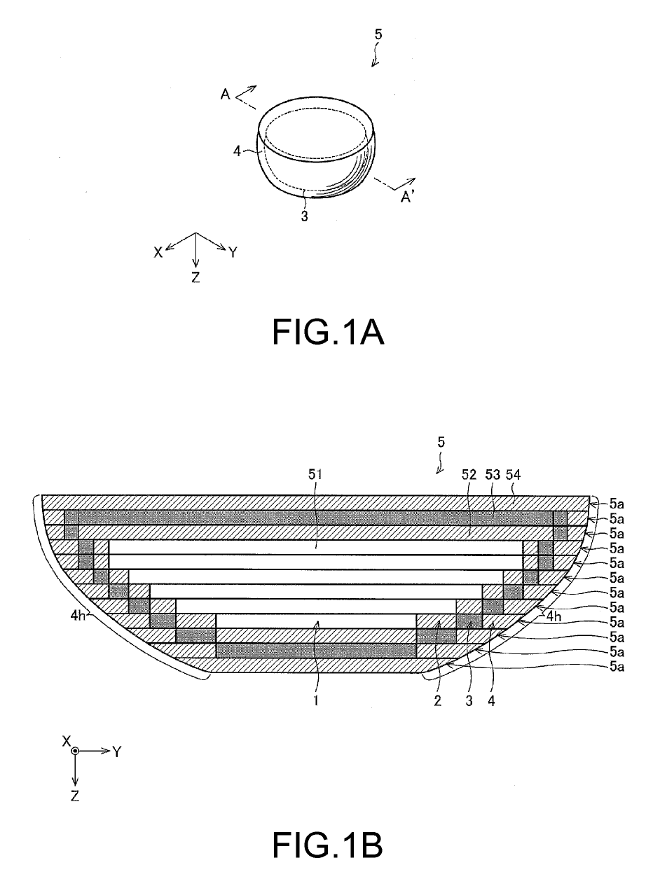

FIGS. 1A and 1B illustrate a three-dimensional object according to this embodiment. FIG. 1 A is an external view of the three-dimensional object. FIG. 1B is a cross-sectional view of the three-dimensional object along a cutting-plane line A-A′ illustrated in FIG. 1A.

As illustrated in FIG. 1A, a three-dimensional object 5 has a substantially semi-spherical shape. The three-dimensional object 5 includes the following layers in the mentioned order from its outermost-layer side (outer peripheral side) toward inside (toward its center): a second transparent layer 4, a colored layer 3 (decorative layer) made of a colorant-containing ink (decorative ink), a first transparent layer 2 (FIG. 1B) made of a transparent ink, and a light reflective layer 1 (FIG. 1B) constituting the body of this object made of an ink having light reflectivity. In the three-dimensional object 5, the light reflective layer 1 at the center is coated with the first transparent layer 2, the colored layer 3, and the second transparent layer 4 in the mentioned order toward the outermost-layer side (outer peripheral side). Stated differently, the three-dimensional object 5 has a three-dimensional body (including the colored layer 3, the first transparent layer 2, and the light reflective layer 1, and having the colored layer 3 as its outermost layer) decorated in colors and covered with the transparent layer (the second transparent layer 4).

The cross section of the three-dimensional object 5 illustrated in FIG. 1B is taken along a Y-Z plane at the center position of this object 5 in an XYZ coordinate system illustrated in FIG. 1A.

As illustrated in FIG. 1B, the three-dimensional object 5 is three-dimensionally formed by vertically laminating a plurality of layers 5a. In the three-dimensional object 5 illustrated in FIG. 1B, 12 layers 5a are laminated on one another in the Z direction. The number of layers, 12, in this description is a non-limiting example of this invention.

As illustrated in FIG. 1B, the three-dimensional object 5 has a structure in which a diameter in a direction perpendicular to the laminating direction (Z direction) increases by degrees in the laminating direction. The lowermost one of the layers 5a has the smallest diameter along the X-Y plane, whereas the uppermost one of the layers 5a has the greatest diameter along the X-Y plane. The diameters of the layers 5a along the X-Y plane are greater by degrees from the lowermost layer 5a toward the uppermost layer 5a. Accordingly, the layers 5a become greater in size by degrees along the X-Y plane from the lower end toward the upper end of this object.

In the three-dimensional object 5, diameters of the layers 5a along the X-Y plane become greater in the laminating direction (Z direction), a surface of this object substantially along the laminating direction (side surface) further protrudes laterally outward in the upper direction, forming a curved surface as illustrated in FIG. 1A.

In case the three-dimensional object having a substantially semi-spherical shape illustrated in FIG. 1 is shaped by the known inkjet printing, a support material is used to laminate layers with greater diameters on layers therebelow with smaller diameters. Specifically, the support material is formed in contiguity with the outer periphery of a lower one of the layers, and part of an upper one of the layers further protruding than the lower layer is formed on the support material. The known inkjet printing, unless the support material is used, the ink is likely to drop downward the ink when it is discharged to form the protruding portion. The support material is not a structural component of the three-dimensional object. Therefore, timely removal of the support material is necessary as described earlier, requiring an additional step. Besides, the conventional technique involving later disposal of the support material is certainly not eco-friendly.

This embodiment employs the inkjet printing as in the conventional art. However, the three-dimensional object 5 illustrated in FIG. 1 may successfully be formed in the absence of a support material. The three-dimensional object forming device and the three-dimensional object forming method according to this embodiment are hereinafter described.

This embodiment using the inkjet printing is a non-limiting example of this invention. This invention is also applicable to any method of forming three-dimensional objects by leveraging the lamination technique using inks.

(2) Three-Dimensional Object Forming Device

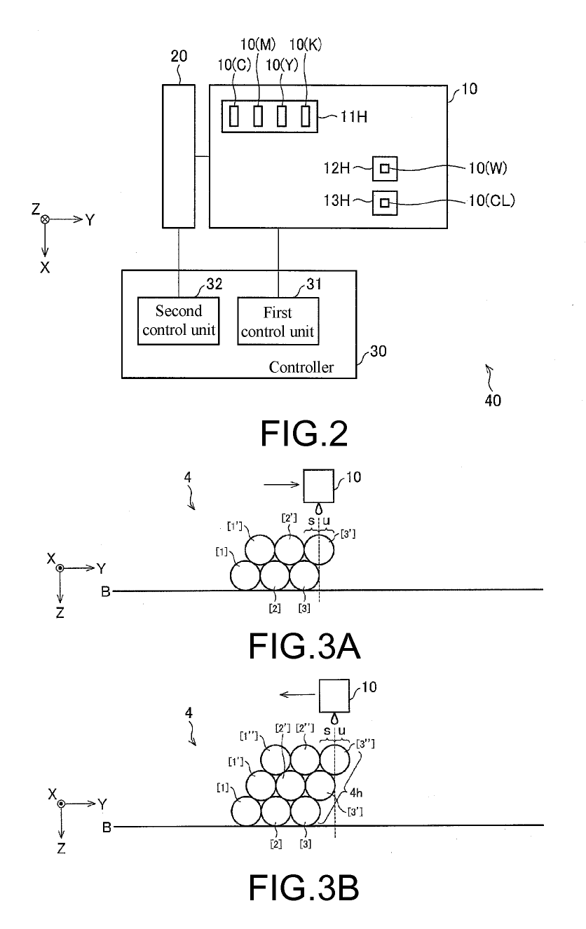

FIG. 2 is a block diagram illustrating principal components of the three-dimensional object forming device according to this embodiment.

A three-dimensional object forming device 40 according to this embodiment illustrated in FIG. 2, includes an inkjet head unit 10, an ultraviolet irradiator 20, and a controller 30.

Inkjet Head Unit 10

FIG. 2 is a drawing of the lower surface of the inkjet head unit 10.

On the lower surface of the inkjet head unit 10, three ink jet heads 11H to 13H are mainly mounted. As illustrated in FIG. 2, a first ink jet head 11H, is disposed at a position displaced from that of a second ink jet head 12H and a third ink jet head 13H in the X direction. And also, the first ink jet head 11H, is disposed at position displaced from that of at a position displaced from that of the second ink jet head 12H and third ink jet head 13H in the Y direction. Briefly, the ink jet heads 11H to 13H are disposed in the generally called staggered arrangement.

The first ink jet head 11H has a cyan ink nozzle 10 (C) for discharging cyan ink, a magenta ink nozzle 10 (M) for discharging magenta ink, a yellow ink nozzle 10 (Y) for discharging yellow ink, and a black ink nozzle 10 (K) for discharging black ink. The arrangement and the number of the nozzles 10 (C), 10 (M), 10 (Y), and 10 (K) are not necessarily limited to the example illustrated in FIG. 2. The inks discharged from these nozzles are all coloring inks used to form the colored layer 3 illustrated in FIGS. 1A and 1B.

The second ink jet head 12H has a white ink nozzle 10 (W) for discharging white ink (W). The white ink (W) is used to form the light reflective layer 1 illustrated in FIG. 1B.

The third ink jet head 13H has a transparent ink nozzle 10 (CL) for discharging transparent ink (CL). The transparent ink (CL) is used to form the first transparent layer 2 illustrated in FIG. 1B and the second transparent layer 4 illustrated in FIG. 1A and 1B.

The inks described above are ultraviolet curing-type inks. The ultraviolet curing-type inks may be quickly curable. This may facilitate the process of laminating ink layers, allowing the three-dimensional object to be manufactured in a shorter period of time. The ultraviolet curing-type inks quickly curable are suitably used in the three-dimensional modeling method according to this embodiment that forms diametrically increased portions without using a support material. To this effect, an ultraviolet curing-type ink is used to form at least the second transparent layer 4 constituting the diametrically increased portions.

The ultraviolet curing-type inks each contain an ultraviolet curing-type compound. The ultraviolet curing-type compound may be selected from any compound curable by being irradiated with ultraviolet light. Examples of the ultraviolet curing-type compounds may include curing-type monomers and curing-type oligomers that are polymerizable by being irradiated with ultraviolet light. Examples of the curing-type monomers may include low-viscosity acrylic monomers, vinyl ethers, oxetane-based monomers, and cycloaliphatic epoxy monomers. Example of the curing-type oligomers may include acrylic oligomers.

The inkjet head unit 10 is disposed so that its lower surface illustrated in FIG. 2 faces the layer-forming surface of a formation table (layer-forming surface B of the formation table is illustrated in FIGS. 3A and 3B) or faces the layer 5a already formed. The inkjet head unit 10 is allowed to reciprocate in the Y direction, and discharges the inks while moving in this direction. The movement of the inkjet head unit 10 is controlled by a first control unit 31 of the controller 30 described later.

The inkjet head unit 10 is moved to an extent that relative positions of the inkjet head unit 10 and the formation table change in a predetermined direction. In that sense, it may be either one of the inkjet head unit 10 and the layer 5a formation table that is moved in a predetermined direction in the XYZ coordinate system.

Ultraviolet Irradiator 20

The ultraviolet irradiator 20 has a light source that emits ultraviolet light to cure the ultraviolet curing-type inks.

The ultraviolet irradiation by the ultraviolet irradiator 20 is controlled by a second control unit 32 of the controller 30.

The ultraviolet irradiator 20 is disposed in vicinity of the inkjet head unit 10 so as to irradiate the inks discharged from the inkjet head unit 10 with ultraviolet light.

Controller 30

The controller 30 includes the first control unit 31 that controls the inkjet head unit 10, and the second control unit 32 that controls the ultraviolet irradiator 20.

The first control unit 31 controls the timing, amount, and power of ink discharge from the inkjet head unit 10. The ink discharge is controlled by regulating a voltage applied to the inkjet head unit 10 from a power source not illustrated in the drawings. The amount and the power of ink discharge are controlled by regulating a voltage applied to the ink-discharge nozzles of the inkjet head unit 10. By the control of the first control unit 31 in this way, not only landing positions of the inks discharged from the inkjet head unit 10 may be controlled, shapes of the inks landing at the positions (shapes of deposited inks) may be controlled.

As described above, the movement of the inkjet head unit 10 is controlled by the first control unit 31.

The second control unit 32 controls the timing of ultraviolet irradiation of the ultraviolet irradiator 20. In case the ultraviolet irradiator 20 needs to be moved along with the movement of the inkjet head unit 10, the movement of the ultraviolet irradiator 20 is also controlled by the second control unit 32.

The controller 30 (the first control unit 31 and the second control unit 32) may be implemented by a logic circuit (hardware) formed by a semiconductor circuit (IC chip), or may be implemented by software run by a central processing unit (CPU). In the latter case, the controller 30 includes the CPU that executes commands of programs installed as software to carry out required functions, a read only memory (ROM) or a recording device (hereinafter, referred to as “recording medium”) in which the programs and different pieces of data are recorded in a computer (or a CPU)-readable manner, and a random access memory (RAM) for deploying the programs. The computer (or CPU) reads the programs from the recording medium and executes the programs to achieve the objective of this invention. The recording medium may be a “non-transitory tangible medium”, examples of which may include tapes, discs, cards, semiconductor memories, and programmable logic circuits. The program may be downloaded into the computer by way of an optional transmission medium (communication network or broadcast wave or the like) through which the programs are transmittable. This invention may be feasible by electronically transmitting the programs in the form of data signals embedded in carrier wave.

By using the three-dimensional object forming device 40 characterized as described so far, the three-dimensional object 5 illustrated in FIG. 1B is formed by the lamination technique using the inkjet printing in the absence of a support material. The three-dimensional object forming device 40 may include other structural elements in addition to the ones illustrated in FIG. 2.

(3) Three-Dimensional Object Forming Method

FIGS. 3A and 3B are schematic drawings, illustrating a three-dimensional object forming method carried out by the three-dimensional object forming device 40 according to this embodiment illustrated in FIG. 2. FIGS. 3A and 3B illustrate a process of three-dimensionally forming portions of the three-dimensional object 5 further protruding laterally outward than the outer peripheral ends of lower layers. In the three-dimensional object 5 according to this embodiment, the second transparent layer 4 illustrated in FIGS. 1A and 1B are used to form these protruding portions.

The protruding portion formed by increasing an upper layer in diameter than a lower layer has no ink deposit immediately therebelow, and is away from the layer-forming surface of the formation table with no contact therebetween. In this context, this portion is referred to as “overhanging portion”. FIGS. 3A and 3B are partial cross-sectional views, illustrating the process of forming the overhanging portion using the second transparent layer 4. These drawings illustrate the process of forming an overhanging portion 4h at the outer peripheral end of the lowermost layer 5a illustrated on the right side in FIG. 1B.

FIG. 3A schematically illustrates the ink discharge from the inkjet head unit 10 moving forward in the arrow-indicated direction along the Y axis in the XYZ coordinate system illustrated in FIG. 3A. By the time when the ink discharge starts, the inkjet head unit 10 has moved backward in the direction of the Y axis along the layer-forming surface B and dropped the ink to form the second transparent layer 4 during this movement in an order of ink [3], ink [2], and ink [1]. A layer is formed by the ink [1], ink [2], and ink [3].

As illustrated in FIG. 3A, the inkjet head unit 10 drops the ink on the layer made of the ink [1], ink [2], and ink [3], while moving forward in the direction of Y axis over the layer, in the order of ink [1′], ink [2′], and ink [3′]. The ink [3′] is discharged so as to have part of this ink (part indicated with “s” in the drawings) overlap with the ink [3] forming the end of the layer formed during the previous movement of the inkjet head unit 10 (discharging step). This may leave a void immediately below the remaining part of the ink [3′] (part indicated with “u” in the drawings).

FIG. 3B illustrates a stage that follows the stage of FIG. 3A. The inkjet head unit 10 discharges the ink, while further moving backward in the direction of Y axis along the layer-forming surface B. FIG. 3B illustrates ink [1″], ink [2″], and ink [3″] discharged then that landed on the layer previously formed. It is only part of the ink [3″] (part indicated with “s” in the drawings) that overlaps with the ink [3′] in the Z direction. The remaining part of the ink [3″] (part indicated with “u” in the drawings) does not overlap with the ink [3′] in the Z direction but extends further outward (lateral side of the three-dimensional object) than the outermost end (illustrated with a broken line in the drawings) of the ink [3′]. The ink [3″] is away from the layer-forming surface B of the formation table, constituting the overhanging portion 4h.

In this embodiment, the ink at the end of a next layer only partly overlaps with the end of the ink layer previously formed. By repeatedly discharging the ink in this manner, no support material is necessary to form the generally called overhanging portion conventionally formed on a support material.

The discharge timing of the inkjet head unit 10 described above is controlled by the first control unit 31.

The “overlap with” in this description means that the layers partly overlap with each other in the Z direction (laminating direction).

To allow the ink to remain at a position obliquely upward on the end of the ink layer previously formed and to stay away from the layer-forming surface B, as the ink [3′] and ink [3″] illustrated in FIG. 3A and 3B, the viscosity of an ink droplet according to an aspect may be in the range of 5 to 25 mPa·sec. This is, however, a non-limiting example of the viscosity that may be optionally changed in the context of ink droplet landing positions (discharge timing from the inkjet head unit 10) and/or other conditions.

The rate of ink discharge according to an aspect may be in the range of 5 to 10 m/sec. This is, however, a non-limiting example of the rate that may be optionally changed in the context of ink droplet landing positions (discharge timing of the inkjet head unit 10) and/or other conditions.

The timing of curing the discharged ink, i.e., the timing of irradiating the discharged ink with ultraviolet light may follow the ink arrival at a set position, or the discharged ink may be precured before arriving at the position. The timing of ultraviolet irradiation may be optionally set by having the second control unit 32 control the ultraviolet irradiator 20. The ultraviolet irradiator 20 may be equipped with a light source for precure in addition to the light source provided to cure the ink.

The foregoing description concerns the technical features of the three-dimensional object forming method carried out by the three-dimensional object forming device 40 according to this embodiment.

(4) Details of Three-Dimensional Object

(4-1) Overall Structure of Three-Dimensional Object

The above discussion in the “(1) Summary of three-dimensional object” solely focuses on the matters directly relevant to the distinctive technical features of this invention. Other technical aspects of the three-dimensional object 5 illustrated in FIG. 1B are hereinafter described.

The thickness (height) of each layer 5a in the Z direction may be appropriately set based on, for example, the number of layers to be formed. In this embodiment that forms a laminate of layers using the inkjet printing, consideration may be given to thicknesses of the layers 5a in the Z direction feasible by the employed method. The thickness of each one of the layers 5a in the Z direction may be mostly between 5 μm and 50 μin. The thicknesses in this range are suitable for multicolor formation of the colored layer 3 by the subtractive color mixture. In this embodiment that uses ultraviolet curing-type inks discharged by the inkjet printing to form the layers, each layer 5a may have a thickness in the range of 5 μm to 30 μm depending on the sizes of ink droplets, and suitably in the range of 10 μm to 25 μm. In case of a large-sized object for which high resolution is not expected, successive layers may be laminated based on the same data, or larger ink droplets may be discharged. This may promise a reduced data volume and a higher object shaping speed.

In the three-dimensional object 5 according to this embodiment, the second transparent layer 4 entirely covers the colored layer 3 to avoid exposure of the colored layer 3. In this embodiment that forms such a three-dimensional structure using the lamination technique, the lowermost and uppermost ones of the layers 5a solely consist of the second transparent layer 4, and the layers 5a each having part of the second transparent layer 4 formed on the outer periphery of part of the colored layer 3 are formed on opposing sides (inner sides) of the lowermost and uppermost layers 5a. On the further inner sides of these layers are formed the layers 5a each having part of the second transparent layer 4, part of the colored layer 3, and part of the first transparent layer 2 formed in this order from the outer peripheral end toward the center. On the further inner sides of these layers are fowled the layers 5a each having part of the second transparent layer 4, part of the colored layer 3, part of the first transparent layer 2, and part of the light reflective layer 1 formed in this order from the outer peripheral end toward the center. The illustration of FIG. 1B only suggests a non-limiting example of the numbers of the respective layers 5a. So far as the three-dimensional object 5 illustrated in FIG. 1A can be formed by the lamination technique, the respective layers 5a are not necessarily structured as described above.

Though the light reflective layer 1 is regarded as the body of the object in this embodiment, the light reflective layer may or may not constitute the body of the object. For example, the three-dimensional object may have a body (may or may not have light reflectivity) or a cavity at its center apart from the light reflective layer. In this instance, the light reflective layer, the first transparent layer, the colored layer, and the second transparent layer may be formed in this order from the body side toward the outermost-layer side (outer peripheral side). Alternatively, a core (may or may not have light reflectivity) and the light reflective layer 1 formed on the surface of the core may be regarded as the body of the object.

(4-2) Laminated Layers

By laminating the layers 5a in the Z direction as illustrated in FIG. 1B, parts 54 of the second transparent layer in the respective layers 5a are substantially continuous along the outermost surface of the three-dimensional object 5, forming the second transparent layer 4. Further, parts 53 of the colored layer in the respective layers 5a are substantially continuous along the outermost surface of the three-dimensional object 5, forming the colored layer 3, parts 52 of the first transparent layer in the respective layers 5a are substantially continuous along the outermost surface of the three-dimensional object 5, forming the first transparent layer 2, and parts 51 of the light reflective layer in the respective layers 5a are substantially continuous along the outermost surface of the three-dimensional object 5, forming the light reflective layer 1. By having the layers thus arranged, the three-dimensional object 5, when viewed in any of the X, Y, and Z directions, has the second transparent layer 4, the colored layer 3, the first transparent layer 2, and the light reflective layer 1 arranged in this order. This may allow a viewer to visually recognize the color tone of the colored layer 3 expressed by the subtractive color mixture.

The parts 52 of the first transparent layer are formed in slightly greater dimensions along the X-Y plane than the parts 53 of the colored layer in vertical contact with the parts 52 of the first transparent layer. This may more certainly prevent the inks forming the colored layer 3 and the light reflective layer 1 from blending into each other.

The parts 54 of the second transparent layer are formed in slightly greater dimensions along the X-Y plane than the parts 53 of the colored layer in vertical contact with the parts 54 of the second transparent layer. This may provide for more reliable protection of the colored layer 3.

(4-3) Specific Features of Layers

Hereinafter are described the light reflective layer 1 (parts 51 of the light reflective layer), the first transparent layer 2 (parts 52 of the first transparent layer), the colored layer 3 (parts 53 of the colored layer), and second transparent layer 4 (parts 54 of the second transparent layer).

Light Reflective Layer 1 (Parts 51 of the Light Reflective Layer)

The light reflective layer 1 (parts 51 of the light reflective layer) is made of an ink having light reflectivity that allows the whole range of visible lights to be reflected from at least a surface of the light-reflective layer 1 close to the colored layer 3.

The light reflective layer 1 (parts 51 of the light-reflective layer) may be made of an ink containing metal powder or an ink containing a white pigment. In an aspect of this invention, this layer may be suitably made of a white ink. The light reflective layer 1 made of a white ink may favorably reflect light incident from the outermost-surface side of the object, allowing the object to be colored by the subtractive color mixture.

In this embodiment, the light reflective layer 1 constitutes the body of the object. In case the light reflective layer 1 is formed on the body surface of an object for which light reflectivity is not required, the thickness of the light reflective layer 1 may be, at minimum, between 5 μm and 20 μm. The thickness of the light reflective layer 1 is equal to the width of the part 51 of the light reflective layer included in the layer 5a from the outer-peripheral side toward the center thereof. This range of values of the thickness is a non-limiting example of this invention.

First Transparent Layer 2 (Parts 52 of the First Transparent Layer)

The first transparent layer 2 (parts 52 of the first transparent layer) is made of a transparent ink.

The transparent ink may be selected from any inks that can form a transparent layer having the light transmittance of 50% or more per unit thickness. The unit thickness is the minimum required dimension of the transparent layer in the X and Y directions, ranging from 5 μm to 20 μm. The light transmittance that falls below 50% per unit thickness of the transparent layer may block light from transmitting through the layer. As a result, the object may fail to exhibit a desired color tone to be achieved by the subtractive color mixture. To this effect, inks that impart the light transmittance of 80% or more per unit thickness to the transparent layer may be used, and inks that impart the light transmittance of 90% or more per unit thickness to the transparent layer may be suitably used.

By interposing the first transparent layer 2 (parts 52 of the first transparent layer) between the light reflective layer 1 (parts 51 of the light reflective layer) and the colored layer 3 (parts 53 of the colored layer), the coloring ink used to form the colored layer 3 and the ink used to form the light reflective layer 1 may be effectively prevented from bleeding into each other. The coloring ink of the colored layer 3 still possibly bleeds into the transparent ink of the first transparent layer 2. Yet, the transparent ink may not pose the risk of spoiling the coloring effect of the colored layer 3, causing no change to a color tone originally intended. Hence, the colored layer 3 may successfully exhibit a desired color tone in the object finally obtained (decorated as desired).

The first transparent layer 2 may have a thickness ranging from 5 μm to 20 μm. The thickness of the first transparent layer 2 is equal to the width of the part 52 of the first transparent layer included in the layer 5a from the outer-peripheral side toward the center thereof. This range of values of the thickness is a non-limiting example of this invention.

Colored Layer 3 (Parts 53 of the Colored Layer)

The colored layer 3 (parts 53 of the colored layer) is made of a colorant-containing coloring ink(s).

Examples of the colorant-containing coloring ink may include inks in yellow (Y), magenta (M), cyan (C), black (K) colors, and pale colors of these colors, and may further include red (R), green (G), blue (B), orange (Or), metallic color, pearl color, and fluorescent color inks. One or more of these exemplified coloring inks may be used to produce a desired color tone.

The amount of the coloring ink used to form the colored layer 3 (parts 53 of the colored layer) may be variable with a desired color tone (to be exhibited). In case a low-concentration bright color tone is desirably obtained, therefore, the coloring ink alone is not enough for the ink density of the colored layer 3 to meet a predetermined ink density, possibly leaving vertically uneven parts in the Z direction and/or inkless dented parts at positions in the X and Y directions. Any of such undesired events may lead to irregularities on the object formed by the lamination technique as described in this embodiment.

In this embodiment, therefore, a supplementary ink is used to increase the ink density of the colored layer 3 (parts 53 of the colored layer) in any region of this layer where the coloring ink alone is not enough for the ink density of the colored layer 3 (parts 53 of the colored layer) to meet a predetermined ink density. The colored layer 3 (parts 53 of the colored layer) is formed, so that the density in total of the coloring and supplementary inks (total volume of ink droplets) is kept constant. This may effectively avoid the possible irregularities on the object, allowing the three-dimensional object 5 to be formed in an elaborate shape.

The discharge amount of the coloring ink and landing positions of the inks included in the coloring ink are previously known. Therefore, the amount of the supplementary ink to be supplied and a position(s) at which the supplementary ink should be supplied (landing position(s)) may be determined based on such known information. The amount and position(s) may be determined by the inkjet head unit 10 or the controller 30 (FIG. 2), or other controllers additionally provided.

By supplying the supplementary ink to increase the ink density, the surface of the colored layer 3 may become flat, imparting glossiness to the object.

The supplementary ink may be selected from any inks that do not adversely affect the color tone to be produced by the colored layer 3 (parts 53 of the colored layer). An example of the supplementary ink may be the transparent ink used to form the first transparent layer 2 (parts 52 of the first transparent layer) and the second transparent layer 4 (parts 54 of the second transparent layer).

The colored layer 3 may have a thickness ranging from 5 μm to 20 μm. The thickness of the colored layer 3 is equal to the width of the part 53 of the colored layer included in the layer 5a from the outer-peripheral side toward the center thereof.

The colored layer 3 described so far in this embodiment is a non-limiting example of this invention. Any one suitably selected from decorative layers may be instead used.

Second Transparent Layer 4 (Parts 54 of the Second Transparent Layer)

The second transparent layer 4 (parts 54 of the second transparent layer) is made of the transparent ink described in relation to the first transparent layer 2 (parts 52 of the first transparent layer). The second transparent layer 4 and the first transparent layer 2 may be made of the same transparent ink or different transparent inks.

The second transparent layer 4 may have a thickness of 10 μm or more. The upper-limit value of the thickness may be appropriately changed in accordance with the outer dimension of the three-dimensional object 5. The thickness of the second transparent layer 4 is equal to the width of the part 54 of the second transparent layer included in the layer 5a from the outer-peripheral side toward the center thereof.

The second transparent layer 4 may serve as the protective layer of the colored layer 3. In this invention (this embodiment) that forms the layers using the lamination technique in the absence of a support material, the second transparent layer 4 may also be useful in manufacturing three-dimensional objects improved in elaborateness. Supposing that the colored layer 3 is the outermost layer of the three-dimensional object 5, i.e., the parts 53 of the colored layer included in the layers 5a are formed on the outermost end of the object 5, the colored layer 3 (parts 53 of the colored layer) may fail to be formed with precision. On the other hand, the colored layer 3 (parts 53 of the colored layer) may be formed with precision by forming the second transparent layer 4 (parts 54 of the second transparent layer) as the outermost layer of the three-dimensional object 5 as described in this embodiment. Thus, the second transparent layer 4 (parts 54 of the second transparent layer) may help the resulting object 5 to exhibit a desired color tone.

The colored layer 3, if formed on the outermost side of the three-dimensional object 5, is exposed unprotected. Then, the colored layer 3 may be easily rubbed and faded in color and/or discolored by being exposed to ultraviolet light. Such color fading and/or discoloration of the colored layer 3 may be prevented in this embodiment by forming the second transparent layer 4 (parts 54 of the second transparent layer) as the outermost layer of the three-dimensional object 5.

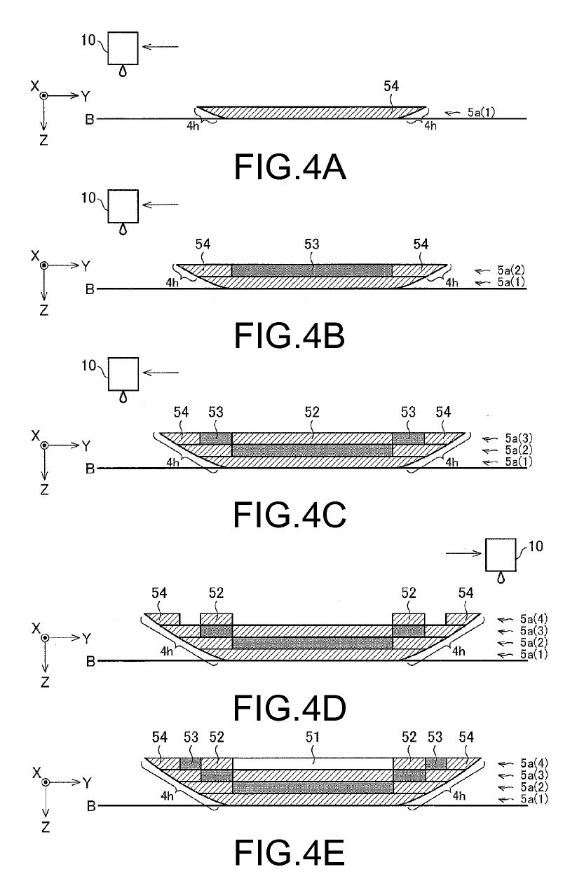

FIGS. 4A to 4E are cross-sectional views, schematically illustrating steps of forming (manufacturing) the overall structure of the three-dimensional object 5 according to this embodiment. These drawings illustrate part of the cross-sectional view of FIG. 1B.

As illustrated in FIG. 4A, a lowermost layer 5a (a first layer 5a (1)) is formed on the layer-forming surface B of the formation table provided as an object-shaping stage. In the step of forming (manufacturing) the first layer 5a (1), the inkjet head unit 10 discharges the transparent ink at a predetermined timing by the inkjet printing, and the discharged ink is irradiated with ultraviolet light to form the first layer 5a (1) solely consisting of the part 54 of the second transparent layer. During the formation of the first layer 5a (1), the overhanging portion 4h is formed at the outer-peripheral end of this layer in the manner described earlier.

Next, a second layer 5a (2) is formed on the first layer 5a (1), as illustrated in FIG. 4B. In the step of forming (manufacturing) the second layer 5a (2), the inkjet head unit 10 moves over the formed first layer 5a (1) and discharges the inks at predetermined timings. The discharged inks are then cured by being irradiated with ultraviolet light to form the second layer 5a (2) including the part 53 of the colored layer at its center and further including the part 54 of the second transparent layer around the part 53 of the colored layer. In the step of forming (manufacturing) the second layer 5a (2), the overhanging portion 4h is formed likewise at the part 54 of the second transparent layer on the outer-peripheral end of the second layer 5a (2).

The part 53 of the colored layer and the part 54 of the second transparent layer may be formed at the same time, or either one of the part 53 of the colored layer and the part 54 of the second transparent layer may be formed before the other layer is formed.

Next, a third layer 5a (3) is formed on the second layer 5a (2), as illustrated in FIG. 4C. In the step of forming (manufacturing) the third layer 5a (3), the inkjet head unit 10 moves over the formed second layer 5a (2) and discharges the inks at predetermined timings. The discharged inks arc then cured by being irradiated with ultraviolet light to form the third layer 5a (3) including the part 52 of the first transparent layer, the part 53 of the colored layer, and the part 54 of the second transparent layer in the mentioned order from the center side toward the end of the third layer 5a (3). In the step of forming (manufacturing) the second layer 5a (3), the overhanging portion 4h is formed likewise at the part 54 of the second transparent layer.

In the step of forming (manufacturing) the third layer 5a (3), all of the part 52 of the first transparent layer, the part 53 of the colored layer, and the part 54 of the second transparent layer may be formed at the same time, or the part 52 of the first transparent layer and the part 54 of the second transparent layer may be formed before the part 53 of the colored layer is formed.

Next, a fourth layer 5a (4) is formed on the third layer 5a (3), as illustrated in FIG. 4D. In the step of forming (manufacturing) the fourth layer 5a (4), the inkjet head unit 10 moves over the formed third layer 5a (3) and discharges the transparent ink at predetermined timings. The discharged ink is then cured by being irradiated with ultraviolet light to form the part 52 of the first transparent layer and the part 54 of the second transparent layer. During the formation of this layer, the overhanging portion 4h is formed likewise at the part 54 of the second transparent layer. Then, the part 51 of the light reflective layer and the part 53 of the colored layer are formed, as illustrated in FIG. 4E. As a result, the fourth layer 5a (4) is formed that includes the part 51 of the light reflective layer, the part 52 of the first transparent layer, the part 53 of the colored layer, and the part 54 of the second transparent layer in the mentioned order from the center side toward the end of the fourth layer 5a (4).

The step of forming (manufacturing) the fourth layer 5a (4) illustrated in FIG. 4D includes steps of forming the part 52 of the first transparent layer and the part 54 of the second transparent layer. In this step, the overhanging portion 4h is formed likewise at the part 54 of the second transparent layer. After that, the part 53 of the colored layer is formed between the part 52 of the first transparent layer and the part 54 of the second transparent layer, and the part 51 of the light reflective layer is also formed, as illustrated in FIG. 4E. At the time of forming the part 53 of the colored layer, the part 54 of the second transparent layer serves as the outer moat for the inks dropped to form the colored layer. This may prevent the inks discharged to form the colored layer from spreading out, allowing the part 53 of the colored layer to be formed with high precision.

To form the part 53 of the colored layer in each layer, an ink containing the coloring ink and the supplementary ink prepared to form the colored layer is discharged in a manner that the total amount of these two inks is constant, and then cured by being irradiated with ultraviolet light.

By thus laminating the layers in the Z direction, the three-dimensional object 5 illustrated in FIG. 1B may be finally obtained. As for the formation of each layer, the known two-dimensional image formation techniques, such as interlace scans and multipass scans, may enable high-quality shaping and decoration while suppressing unevenness.

(5) Modified Examples of the Three-Dimensional Object

(5-1) Modified Example 1

The three-dimensional object 5 may have a strap hole formed in part of the second transparent layer 4. This hole may be formed in the step of forming the second transparent layer 4 by partly not forming the second transparent layer 4.

(5-2) Modified Example 2

The three-dimensional object 5 may have, on the surface or inside of the second transparent layer 4, a mark, a frame, and/or a decorative three-dimensional image displayed in pale colors, and/or a character structure denoting date, name, and/or place. Such pieces of additional information including a decorative three-dimensional image and a character structure may be added to the object by having the controller 30 control the inkjet head unit 10. The additional pieces of information may be formed in parallel with the formation of the second transparent layer 4.

(5-3) Modified Example 3

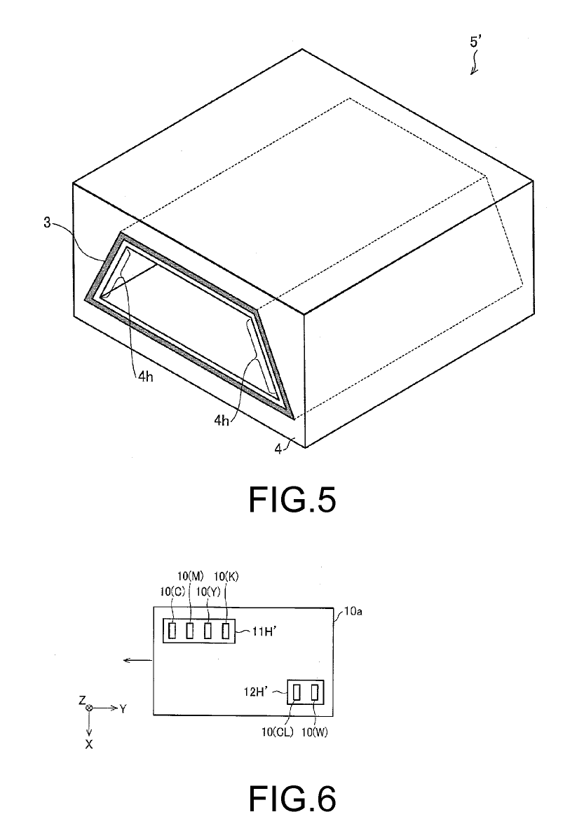

In the three-dimensional object 5 according to this embodiment, the layers 5a are increasingly greater in diameter toward the outer side in the laminating direction. The three-dimensional object forming device and the three-dimensional object forming method according to this invention may be used to form a three-dimensional object 5′ increasingly smaller in diameter toward the inner side in the laminating direction, as illustrated in FIG. 5. The three-dimensional object 5′ illustrated in FIG. 5 also has the overhanging portion 4h, which may be formed in the absence of a support material by dropping the inks in the described manner.

(6) Modified Examples of Inkjet Head Unit

The above embodiment manufactures the three-dimensional object 5 using the inkjet head unit 10 illustrated in FIG. 2. This is, however, a non-limiting example of usable inkjet head units and may be replaced with any one of inkjet head units illustrated in FIGS. 6 to 9.

The lower surface of an inkjet head unit 10a illustrated in FIG. 6 are mounted with ink jet heads that are mainly divided into two ink jet heads 11H′ and 12H′. As illustrated in FIG. 6, the first ink jet head 11H′ and the second ink jet head 12H′ are disposed at positions displaced from each another in both of the X and Y directions.

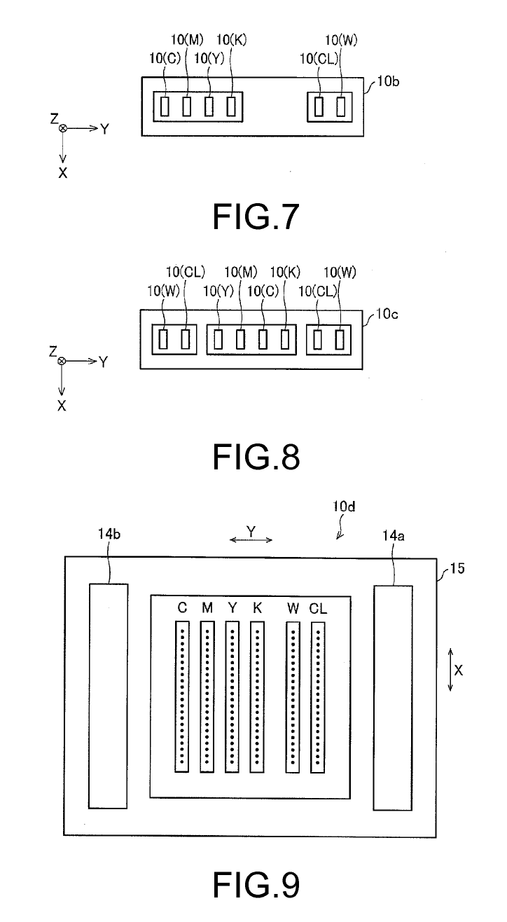

FIG. 7 is a drawing of another modified example of the inkjet head unit. On the lower surface of an inkjet head unit 10b illustrated in FIG. 7, a cyan ink nozzle 10 (C), a magenta ink nozzle 10 (M), a yellow ink nozzle 10 (Y), a black ink nozzle 10 (K), a transparent ink nozzle 10 (CL), and a white ink nozzle 10 (W) are arranged in this order in the Y direction.

FIG. 8 is a drawing of further another modified example of the inkjet head unit. On the lower surface of an inkjet head unit 10c illustrated in FIG. 8, a white ink nozzle 10 (W), a transparent ink nozzle 10 (CL), a yellow ink nozzle 10 (Y), a magenta ink nozzle 10 (M), a cyan ink nozzle 10 (C), a black ink nozzle 10 (K), a transparent ink nozzle 10 (CL), and a white ink nozzle 10 (W) are arranged in this order in the Y direction.

FIG. 9 is a drawing of further another modified example of the inkjet head unit. An inkjet head unit 10d illustrated in FIG. 9 has a carriage 15 capable of reciprocating along the Y axis, a plurality of nozzle arrays mounted in the carriage 15, and ultraviolet irradiators 14a and 14b also mounted in the carriage 15. The inkjet head unit 10d moves the carriage 15 in the Y direction and discharges the ultraviolet curing-type inks from the nozzle arrays. Further, the inkjet head unit 10d performs scans to emit ultraviolet light from the ultraviolet irradiators 14a and 14b. The nozzle arrays are aligned in a row in the Y direction, as illustrated in FIG. 9. From the left to right in the Y direction on the drawing, a cyan ink nozzle 10 C, a magenta ink nozzle 10 M, a yellow ink nozzle 10 Y, a black ink nozzle 10 K, a white ink nozzle 10 W, and a transparent ink nozzle 10 CL are arranged in the mentioned order. The nozzle arrays mounted in the carriage 15 are allowed to discharge the ultraviolet curing-type inks when moving in the Y direction along with the movement of the carriage 15.

As for the inkjet head unit illustrated in FIGS. 7, 8, and 9, all of the nozzles are arranged in the Y direction. Therefore, all of the inks for one layer may be discharged to form the layer by moving the nozzles once in the Y direction. As for the inkjet head unit illustrated in FIG. 9, the inks are discharged and irradiated with ultraviolet light at the same time by moving the nozzles once in the Y direction. Therefore, one layer made of the ultraviolet curing-type inks may be cured at the same timing as the ink discharge.

(6) Modified Example of Three-Dimensional Object Forming Device and Method

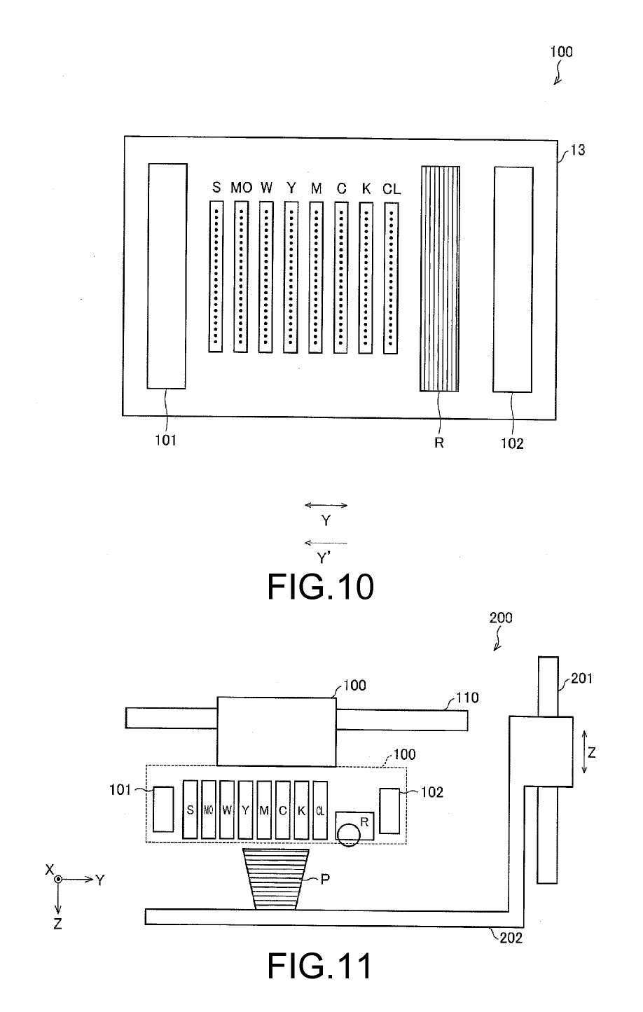

Next, another embodiment of the three-dimensional object forming device and method is hereinafter described referring to FIGS. 10 to 13. FIG. 10 is a schematic drawing of an inkjet head unit 100 equipped in a three-dimensional object forming device 200 according to another embodiment of this invention. FIGS. 11 to 13 are schematic drawings of a method of manufacturing a three-dimensional object using the three-dimensional object forming device 200.

First, structural features of the inkjet head unit 100 are described. As illustrated in FIG. 10, the inkjet head unit 100 has nozzles Y, M, C, K, CL, W, MO, and S that respectively discharge yellow (Y), magenta (M), cyan (C), and black (K) inks, a transparent ink, a white ink, a modeling material, and a support material. This invention is directed to manufacture of a three-dimensional object without using any support material. The inkjet head unit 100, however, has the nozzle S for the use of a support material depending on the shape of an overhanging portion to be um tied.

The inkjet head unit 100 further has a roller (pressing mechanism) R, and ultraviolet irradiators 101 and 102. The roller R is disposed in adjacency to the nozzles Y, M, C, K, CL, W, MO, and S in the direction of arrow Y (a sub scanning direction). The roller R is disposed so that its rotating axis is in parallel with the nozzle arrays, and the length of the roller R in its rotating axis is greater than, equal to, or substantially equal to the length of the nozzle arrays. All of the inks discharged in one main scan can be pressed by the roller R.

In this embodiment, the ink layer formed may be flattened and uniformed in thickness by the roller R. Specifically, the roller R, while rotating, moves in the direction of arrow Y′ on the ink layers made of the inks discharged from the nozzles Y, M, C, K, CL, W, MO, and S to press the ink layers. This may flatten and uniform the ink layers in thickness.

As illustrated in FIG. 11, the three-dimensional object forming device 200 has the inkjet head unit 100, a Y bar 110, a height direction guide bar 201, and an object-shaping table 202. The surface of the inkjet head unit 100 mounted with the nozzles is illustrated in FIG. 11 with a broken line to simplify the illustration. FIG. 11 illustrates the three-dimensional object forming device 200 viewed in the direction of arrow X, however, the inkjet head unit 100 shows a side surface thereof illustrated with a solid line and indicated with the reference sign 100.

The Y bar 110 defines the trajectory of the inkjet head unit 100 moving in the Y direction (the sub scanning direction). The inkjet head unit 100 is attached to the Y bar 110 and moves in the lengthwise direction of the Y bar 110.

The height direction guide bar 201 is used to change the height of the object-shaping table 202. The object-shaping table 202 is attached to the height direction guide bar 201 and moves in the lengthwise direction of the height direction guide bar 201. The height of the object-shaping table 202 may be thereby adjusted.

The inks discharged from the inkjet head unit 100 are deposited in layers on the object-shaping table 202 to form a three-dimensional object P on the object-shaping table 202. After one layer is formed by discharging the inks from the inkjet head unit 100, the object-shaping table 202 moves vertically downward. The three-dimensional object P may be accordingly formed, with a distance between an ink-discharge position and an ink-landing surface being constantly adjusted. This is, however, a non-limiting example of this invention. Instead of moving the object-shaping table, the inkjet head unit 100 may be moved vertically upward.

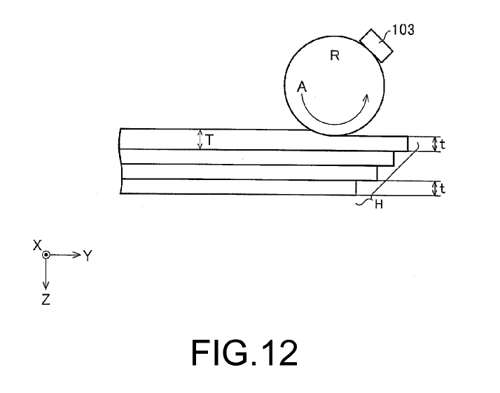

Referring to FIG. 12, description will be given of the process of pressing the ink layers using the roller R to flatten the layers and to adjust the height of each layer to a desired uniform dimension.

A reference sign “T” represents the thickness of the ink layer before being pressed by the roller R, and “t” represents the thickness of the pressed ink layer. FIG. 12 illustrates three layers formed and pressed by the roller R and thereby reduced to the thickness t. In the description given below, “Vy” represents the moving speed of the inkjet head unit 100 in the Y direction, and “Vr” represents the circumferential speed of the roller R in the direction of arrow A (speed of rotation of its outer peripheral surface).

As illustrated in FIG. 12, the ink that just landed on the layer previously formed has the thickness T. The roller R provided in the inkjet head unit 100 moves on this ink layer at a speed Vy in the Y direction. The roller R rotates in a direction opposite to the moving direction of the inkjet head unit 100, with a circumferential speed Vr equaling to the speed Vy speeds. Under the conditions, the roller R moves, pressing the upper surface of the uppermost ink layer in the direction of Z axis without sliding on the layer (rubbing the layer). As a result, the uppermost layer is pressed in the direction of Z axis and reduced to the thickness t.

For example, the thickness T is 15 μm on average, and the thickness t is 14 μm on average. The volume of discharged ink droplets, which may depend on the inkjet head unit 100 or the like used, may be variable by approximately ±10%. In that sense, the uppermost layer may have irregularities ranging from 13.5 μm to 16.5 μm in its thickness. By pressing and flattening the uppermost layer with such irregularities using the roller R, the thickness t may become uniformly 14 μm. The thickness t, if greater than the average value of the thickness T, may leave voids in the object. On the other hand, in case the thickness t is less than the average value of the thickness T, a difference to the actual value of T may pose the risk of spreading the uppermost layer in the X and Y directions. The voids, if continue to be formed, may result in irregularities. Therefore, the thickness t may be equal to or slightly less than the average value of the thickness T.

To form the three-dimensional object P, the object-shaping table may be moved by 14 μm forward in the direction of Z axis or the inkjet head unit 100 may be moved by 14 μm backward in the direction of Z axis after each layer is formed. The roller R may press each one layer that has been formed, or may collectively press plural layers.

In this embodiment of the invention, an overhanging portion H may be formed without the use of a support material as in the earlier embodiment. The inclination of the overhanging portion may be adjustable by regulating the pressing force of the roller R. The roller R, by pressing the ink layer, pushes the ink layer end outward, increasing a portion of the next layer that receives ink droplets dropping on the outermost side. The ink droplets discharged in a next scan and dropping on the portion may be prevented from falling further downward on the object-shaping table 202. The ink droplets may easily partly overlap with the outer side of the layer previously formed, facilitating the manufacture of a three-dimensional object with such an overhanging portion in the absence of a support material. During the lamination of layers, the object may expand in the X and Y directions due to the pressing in the direction of Z axis, however, by only a small margin. It may be a solution to form a cavity inside the object that serves to absorb the possible expansion.

Though specifics of the roller R may not be particularly limited, its outer peripheral surface may include a material with no affinity to the inks. The roller R may be a metal roller whose surface is coated with a fluorine-based material, such as PTFE (polytetrafluoroethylene), or a metal roller to which fluorine-based or silicon-based rubber is bonded.

As illustrated in FIG. 12, the inkjet head unit 100 includes a pad 103. The pad 103 is used to clean the roller R to remove the inks adhered to the roller R. A material, such as felt, may be used to form the pad 103.

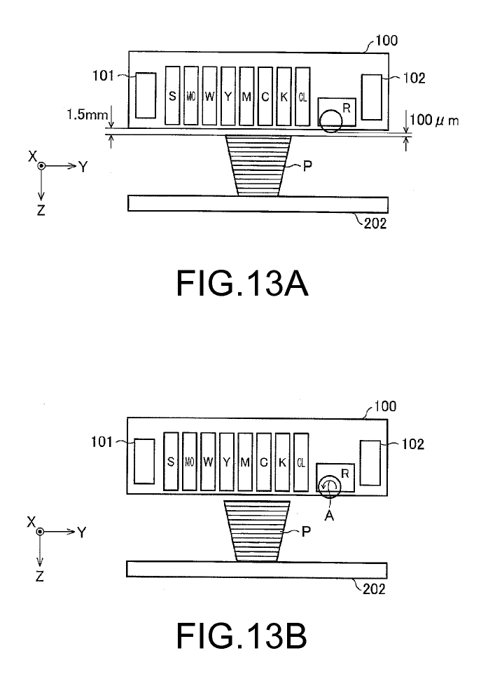

Referring to FIGS. 13A-13B, description will be given of the process of manufacturing the three-dimensional object P by pressing every two layers formed using the roller R.

As illustrated in FIG. 13A, the inks are discharged from the inkjet head unit 100 moving forward in the direction of Y axis. The inks are discharged based on object-shaping data and coloring data. The object-shaping table 202 is set at a position high enough to avoid contact between the ink-discharge target surface and the lower end of the roller R. For example, a distance between the lower end of the nozzle surface and the ink-discharge target surface is 1.5 mm, and a distance between the lower end of the roller R and the ink-discharge target surface is 100 μm.

When the inks are discharged through the nozzles, the inks that form the uppermost layer are cured by being irradiated with ultraviolet light emitted from the ultraviolet irradiator 101. Instead of emitting ultraviolet light from the ultraviolet irradiator 101, every two layers pressed by the roller R may be irradiated with ultraviolet light emitted from the ultraviolet irradiator 102, or every three layers may be irradiated with ultraviolet light.

After the uppermost layer is formed, the object-shaping table 202 is pushed upward, so that the upper surface of the layer subsequently formed can be pressed by the roller R. The distance between the lower end of the roller R and the ink-discharge target surface is set to 100 μm to ensure that the roller R is distant enough from the uppermost layer to avoid any contact therebetween. By pushing the table upward, the upper surface of the layer subsequently formed can be pressed by the roller R.

In case the thickness of one layer after being pressed is desirably 14 μm, the object-shaping table 202 is pushed upward by 72 μm. Then, the distance between the lower surface of the roller R and the uppermost layer is 28 μm before the two layers are formed, while the height T of two layers in total is 30 μm. The two layers pressed by the roller R may become flat, with the total thickness of 28 μm.

After the distance between the lower surface of the roller R and the uppermost layer before two layers are formed is set as 28 μm, as illustrated in FIG. 13B, the inks are discharged from the inkjet head unit 100 moving backward in the direction of Y axis to form new layers. The roller R, while rotating in the direction of arrow A at a circumferential speed equal to the moving speed Vy of the inkjet head unit 100, presses the new layers. Further, ultraviolet light is emitted from the ultraviolet irradiator 102 to cure the resulting ink layers.

As a result, two ink layers having the total height of 28 μm are formed. By repeating the operation described so far, the flattening is performed once in each reciprocating scan in the direction of Y axis to manufacture the three-dimensional object P.

An ultraviolet irradiator for precure may be further provided between the nozzles and the roller R to press the precured layers.

[Additional Remarks]

The three-dimensional object forming device 40 according to an aspect of this invention forms a three-dimensional object by layering a plurality of layers made of ink. This device is configured to discharge the ink at the time of forming a next layer on a layer previously formed so as to have part of the ink forming an end of the next layer that is close to an end of the layer previously formed overlap with the ink forming the end of the layer previously formed to provide a void immediately below the remaining part of the ink of the next layer.

Such a device may dispense with the use of a support material to form the overhanging portion.

In an inner region relative to the end of the ink layer previously formed, part of the ink forming a next ink layer, which is nearer to the end, overlaps with the ink of the previous layer to provide a void immediately below the remaining part of the ink of the next layer. The remaining part of the ink with a void immediately therebelow constitutes the overhanging portion formed on the end of the ink-deposited layer previously formed and protruding from this end.

The forming device equipped with the inkjet head unit 100 using the forming method may successfully form the overhanging portion without any support material. Such a device can dispense with the labor of forming a support material, thereby reducing associated costs conventionally required to form a support material. According to this invention, removal of a support material may become unnecessary. This may expedite the forming of a three-dimensional object as compared with the conventional means requiring the use of a support material. This invention having no need for the waste disposal of a support material may allow a three-dimensional object to be formed in an eco-friendly manner.

In an aspect of the three-dimensional object forming device 40 according to this invention, the ink may be a transparent ink.

Using the transparent ink to form the overhanging portion may avoid the risk of the overhanging portion adversely affecting the color tone of a three-dimensional object.

In an aspect of the three-dimensional object forming device according to this invention, the ink may be an ultraviolet curing-type ink.

The ultraviolet curing-type ink may be quickly curable. This may facilitate the process of laminating ink layers, allowing a three-dimensional object to be manufactured in a shorter period of time.

In an aspect of the three-dimensional object forming device according to this invention, the device may include a roller R that contacts and presses an uppermost one of the ink layers from above.

The ink layer, being pressed by the pressing mechanism, may become flat and uniform in thickness. Further, the pressing mechanism may stretch the ink layer in its planar direction, facilitating the formation of the overhanging portion.

In an aspect of the three-dimensional object forming device according to this invention, the pressing mechanism may be a roller R that rotates while moving in contact with an upper surface of the layer to be pressed and that rotates at a position of contact in a direction opposite to a moving direction.

Such a roller R may move, pressing the upper surface of the uppermost one of the ink layers downward without sliding on the layer (rubbing the layer). This may allow the roller to continue to move in the moving direction while constantly pressing the uppermost layer from above.

In an aspect of the three-dimensional object forming device according to this invention, the roller R may have a surface made of a material with no affinity to the ink.

This may prevent the ink from being adhered to the roller surface.

A three-dimensional object forming method according to an aspect of this invention forms a three-dimensional object by layering a plurality of layers made of inks. This method includes a discharging step of discharging the ink at the time of forming a next layer on a layer previously formed so as to have part of the ink forming an end of the next layer that is close to an end of the layer previously formed overlap with the ink forming the end of the layer previously formed to provide a void immediately below the remaining part of the ink of the next layer.

Such a method may dispense with the use of a support material to form the overhanging portion.

In an inner region relative to the end of the ink layer previously formed, part of the ink forming the next ink layer, which is close to the end, overlaps with the ink of the previous layer to provide a void immediately below the remaining part of the ink of the next layer. The remaining part of the ink with a void immediately therebelow constitutes the overhanging portion formed on the end of the ink-deposited layer previously formed and protruding from this end.

The forming method thus characterized may successfully form the overhanging portion without using any support material. Such a method can dispense with the labor of forming a support material, thereby reducing associated costs conventionally required to form a support material. According to this invention, removal of a support material may become unnecessary. This may expedite the forming of a three-dimensional object as compared with the conventional means requiring the use of a support material. This invention having no need for the waste disposal of a support material may allow a three-dimensional object to be formed in an eco-friendly manner.

This invention is not necessarily limited to the embodiments described above and may be carried out in many other forms. The technical scope of this invention encompasses any of such modifications, and embodiments obtained by variously combining the technical means described in the embodiments.

### INDUSTRIAL APPLICABILITY

This invention is broadly applicable to all kinds of the three-dimensional object forming devices for forming three-dimensional objects including three-dimensional object vending machines developed to automatically form and sell three-dimensional objects.

1. A three-dimensional object forming device for forming a three-dimensional object by layering a plurality of layers made of ink, wherein
the three-dimensional object forming device being configured to discharge an ink at a time of forming a next layer on a layer previously formed, so as to have part of the ink forming an end of the next layer that is close to an end of the layer previously formed, overlap with the ink forming the end of the layer previously formed to provide a void immediately below a remaining part of the ink of the next layer.

2. The three-dimensional object forming device as set forth in claim 1, wherein
the ink is a transparent ink.

3. The three-dimensional object forming device as set forth in claim 1, wherein
the ink is an ultraviolet curing-type ink.

4. The three-dimensional object forming device as set forth in claim 1, further comprising:
a pressing mechanism that contacts and presses an uppermost one of the ink layers from above.

5. The three-dimensional object forming device as set forth in claim 4, wherein
the pressing mechanism is a roller that rotates while moving in a moving direction in contact with an upper surface of a layer to be pressed and that rotates at a position of contact in a direction opposite to the moving direction.

6. The three-dimensional object forming device as set forth in claim 5, wherein
the roller has a surface made of a material with no affinity to the ink.

7. A three-dimensional object forming method of forming a three-dimensional object by layering a plurality of layers made of ink, wherein
the three-dimensional object forming method comprising:
a discharging step of discharging an ink at a time of forming a next layer on a layer previously formed, so as to have part of the ink forming an end of the next layer that is close to an end of the layer previously formed, overlap with the ink forming the end of the layer previously formed to provide a void immediately below a remaining part of the ink of the next layer.

8. The three-dimensional object forming device as set forth in claim 2, further comprising:
a pressing mechanism that contacts and presses an uppermost one of the ink layers from above.

9. The three-dimensional object forming device as set forth in claim 3, further comprising:
a pressing mechanism that contacts and presses an uppermost one of the ink layers from above.
